(19) United States
(12) Patent Application Publication
(10) Pub. No.: US 2008/0122811 A1
(43) Pub. Date: May 29, 2008

(54) Driver Monolithic Liquid Crystal Panel Driver Circuit And Liquid Crystal Display Having Same

(76) Inventor: Daiji Kitagawa, Itabashi-ku (JP)

Correspondence Address: HARNESS, DICKEY & PIERCE, P.L.C., P.O. BOX 8910, RESTON, VA, 20195, US

(21) Appl. No.: 11/663,335

(22) PCT Filed: Sep. 12, 2005
(86) PCT No.: PCT/JP05/16722

§ 371 Date: Mar. 21, 2007

(30) Foreign Application Priority Data
Sep. 22, 2004 (JP) 2004-274610

(51) Int. Cl. G06F 3/038; G09G 3/36

(52) U.S. Cl. 345/204; 345/87

(57) ABSTRACT

A liquid crystal display including liquid crystal panels of different sizes for displaying an image through a phase-developed image signal and having a reduced circuit scale is disclosed. A liquid crystal panel drive circuit is used for driving first and second liquid crystal panels of driver monolithic type having different sizes. External image data is temporarily stored in an image memory through a host interface section. A read control section reads the image data from the image memory in such a way that a two-phase developed image signal is outputted if the operating panel is the first liquid crystal panel and a single-phase developed image signal is outputted if the operating panel is the second one. The thus generated phase developed image signal is supplied as an analog video signal to the operating panel out of the first and second liquid crystal panels through a gamma conversion section, a D/A conversion section, an output section. The invention is suited to a liquid crystal display having driver monolithic liquid crystal panels of different sizes.

### TECHNICAL FIELD

The present invention relates to drive circuits for liquid crystal panels in which their data signal drive circuit and other components are formed integrally with the display section on the same substrate; in other words, the present invention relates to drive circuits for driver monolithic liquid crystal panel, and to liquid crystal display apparatuses including such a drive circuit. In particular, the present invention relates to a liquid crystal display apparatus having a plurality of driver monolithic liquid crystal panels each having a different size from others, and drive circuits therefor.

### BACKGROUND ART

In recent years, liquid crystal display apparatuses having a plurality of liquid crystal panels are used in folding-type mobile telephones for example. FIG. 15 is a schematic block diagram of a conventional liquid crystal display apparatus which has two liquid crystal panels. As shown in FIG. 15, the liquid crystal display apparatus includes a first liquid crystal panel drive circuit 710 and a second liquid crystal panel drive circuit 720. The first liquid, crystal panel drive circuit 710 includes a first image memory 71 and a first phase-expansion section 73, whereas the second liquid crystal panel drive circuit 720 includes a second image memory 72 and a second phase-expansion section 74. The first image memory 71 and the second image memory 72 receive image data which represent images to be displayed, from an external CPU 800. In other words, the CPU 800 stores the image data which represent images to be displayed, selectively in the first image memory 71 or the second image memory 72, depending on the liquid crystal panel which is supposed to display the image. The first phase-expansion section 73 reads image data stored in the first image memory 71, as digital image signals, and performs a phase expansion process to be described later to the digital image signals. The phase expansion process yields digital image signals, which then undergo a D/A conversion process and are converted into analog image signals. The analog image signals are supplied to the first liquid crystal panel 610. The second phase-expansion section 74 reads image data stored in the second image memory 72, as digital image signals, and performs a phase expansion process to the digital mage signals. The phase expansion process yields digital image signals, which then undergo a D/A conversion process and are converted into analog image signals. The analog image signals are supplied to the second liquid crystal panel 620.

Herein, the term phase expansion process refers to an operation performed to make an appropriate display of an image carried by high frequency image signals: Specifically, signal application duration per dot or per pixel (hereinafter called “signal duration per dot” or “signal duration per pixel”) is increased so as to decrease the frequency of the image signal supplied to the liquid crystal panel. It should be understood that a phase expansion process by which the signal duration per dot is increased to n times of the dot clock (pulse repetition) period will be called “n-phase expansion”. A phase expansion process with n=1, i.e. a 1-phase expansion process means that no phase expansion is performed actually (no frequency reduction is made in the image signals); however, the term “phase expansion process” will include the case where n=1, in the present description.

FIG. 16 shows part of a configuration of a source driver 300 as a data signal line drive circuit for a liquid crystal display apparatus designed to perform a 2-phase expansion. The source driver 300 is supplied with an analog video signal AV generated in a 2-phase expansion operation by a liquid crystal panel drive circuit, for each of the colors R (red), G (green) and B (blue). The signal is supplied via six signal lines. A shift register 31 causes sequential output of sampling pulses in the order from its input end to its output ends, from each of flip-flop circuits FF1, FF2, . . . In each shift, the analog video signal AV sent from the liquid crystal panel drive circuit is supplied to the liquid crystal panel, by the amount for two pixels, for displaying an image (Note that the pixel herein is made of three consecutive sub-pixels R, G and B). It should also be noted here that throughout the description, image signals generated by an n-phase expansion operation will be called “n-phase expansion signals”.

The number of phases in a phase expansion process performed for appropriate display of images in a liquid crystal panel is determined in accordance with the size of the liquid crystal panel. Therefore, if the size of the first liquid crystal panel 610 differs from the size of the second liquid crystal panel 620, the number of phases in the phase expansion process performed for the first liquid crystal panel 610 may be different from the number of phases in the process performed for the second liquid crystal panel 620. For example, the first liquid crystal panel 610 may require 2-phase expansion for image display whereas the second liquid crystal panel 620 may require 1-phase expansion (Performing a “1-phase expansion” means no phase expansion is performed. However, for the sake of descriptive convenience, the expression “to perform a 1-phase expansion” will be used throughout the present description, when describing a case where there is no phase expansion performed). In such a case, a configuration shown in FIG. 15 is used, where there are two liquid crystal panel drive circuits, with one of the liquid crystal panel drive circuit performing a 2-phase expansion process while the other liquid crystal panel drive circuit performing a 1-phase expansion process. This is the current way to provide liquid crystal display apparatuses which have two liquid crystal panels differing from each other in the size. With regard to the phase expansion process described above, disclosures have been made for techniques to reduce display nonuniformity, and techniques to reduce circuit sizes for reduced cost. These and other techniques related to the present invention are disclosed in documents listed be low:

[Patent Document 1] JP-A 9-269754 Gazette

[Patent Document 2] JP-A 2000-330499 Gazette

[Patent Document 3] JP-A 2003-229953 Gazette

### DISCLOSURE OF THE INVENTION

### Problems to be Solved by the Invention

However, in order to perform a plurality of phase expansion processes each having a different number of phases from others, the conventional configuration as described above requires a plurality of liquid crystal panel drive circuits for driving the respective liquid crystal panels. This results in increased circuit size and increased cost of manufacture.

It is therefore an object of the present invention to provide a liquid crystal display apparatus which has a reduced circuit size while having a plurality of liquid crystal panels of different sizes each for displaying images based on phase-expanded image signals. Another object of the present invention is to provide a drive circuit capable of driving these liquid crystal panels of different sizes while being compact in size.

### Means for Solving the Problems

A first aspect of the present invention provides a drive circuit for driving a driver monolithic liquid crystal panel including: a plurality of pixel formation sections for forming an image to be displayed; a plurality of data signal lines for supplying the pixel formation sections with signals which represent the image to be displayed; and a data signal line drive circuit for driving the data signal lines in dot sequential drive method by sequential application to the data signal lines of image signals inputted as a representation of the image to be displayed. The drive circuit for driving the driver monolithic liquid crystal panel includes:

a first phase-expansion section for generating a first phase-expansion signal which is a digital image signal made from image data inputted as a representation of the image to be displayed, through phase expansion into a first number of phases;

a second phase-expansion section for generating a second phase-expansion signal which is a digital image signal made from the image data through phase expansion into a second number of phases that is smaller than the first number of phases;

an output section for outputting an image signal which is equivalent to the first or the second phase-expansion signal, as the image signal to be inputted to the data signal line drive circuit; and

a switching section for switching the image signal outputted from the output section, at least between the image signal which is equivalent to the first phase-expansion signal and the image signal which is equivalent to the second phase-expansion signal.

A second aspect of the present invention provides the drive circuit according to the first aspect, further including a memory for storing the image data:

The first phase-expansion section generates the first phase-expansion signal by reading and processing the image data from the memory at a speed corresponding to the first number of phases; and

the second phase-expansion section generates the second phase-expansion signal by reading and processing the image data from the memory at a speed corresponding to the second number of phases.

A third aspect of the present invention provides the drive circuit according to the first aspect, further including a memory for storing the image data:

The first phase-expansion section is provided by a read controlling section which reads the image data from the memory so that data read from the memory in the form of a signal provides the first phase-expansion signal; and

the second phase-expansion section is provided by a read controlling section which reads the image data from the memory so that data read from the memory in the form of a signal provides the second phase-expansion signal.

A fourth aspect of the present invention provides the drive circuit according to the first aspect, further including a conversion section for generating a first analog image signal by converting the first phase-expansion signal into an analog signal, and a second analog image signal by converting the second phase-expansion signal into an analog signal:

The output section includes;

a first output buffer section for outputting the first analog image signal as the image signal to be inputted to the data signal line drive circuit, and

a second output buffer section for outputting the second analog image signal as the image signal to be inputted to the data signal line drive circuit.

A fifth aspect of the present invention provides the drive circuit according to the fourth aspect, further including a buffer control section for stopping operation of the second output buffer section when the first analog image signal is outputted from the output section via the first output buffer section, and for stopping operation of the first output buffer section when the second analog image signal is outputted from the output section via the second output buffer section.

A sixth aspect of the present invention provides the drive circuit according to the first aspect, further including a conversion section for generating a first analog image signal by converting the first phase-expansion signal into an analog signal, and a second analog image signal by converting the second phase-expansion signal into an analog signal:

The output section

includes a number of buffers corresponding to the first number of phases for outputting the first analog image signal as the image signal to be inputted to the data signal line drive circuit, and

outputs the second analog image signal, if the image signal to be outputted from the output section is the second analog image signal which is equivalent to the second phase-expansion signal, via a number of buffers corresponding to the second number of phases which are those buffers preselected from the number of buffers corresponding to the first number of phases.

A seventh aspect of the present invention provides the drive circuit according to the sixth aspect, further including a buffer control section for stopping operation of those buffers that are not preselected from the number of buffers corresponding to the first number of phases when the second analog image signal is outputted from the output section via the preselected buffers.

An eighth aspect of the present invention provides a liquid crystal display apparatus which includes:

the drive circuit according to one of the first through the fifth aspects of the present invention;

a first liquid crystal panel categorized as the driver monolithic liquid crystal panel, for displaying an image based on an image signal outputted from the output section when the image signal is equivalent to the first phase-expansion signal; and

a second liquid crystal panel categorized as the driver monolithic liquid crystal panel, for displaying an image based on an image signal outputted from the output section when the image signal is equivalent to the second phase-expansion signal.

A ninth aspect of the present invention provides a liquid crystal display apparatus which includes:

the drive circuit according to the sixth or the seventh aspect of the present invention;

a first liquid crystal panel categorized as the driver monolithic liquid crystal panel, for displaying an image based on the first analog image signal;

a second liquid crystal panel categorized as the driver monolithic liquid crystal panel, for displaying an image based on the second analog image signal; and

a number of signal lines corresponding to the first number of phases for sending the first analog image signal to the first liquid crystal panel when the first analog image signal is outputted from the output section:

The second analog image signal outputted from the output section is sent to the second liquid crystal panel by a number of signal lines corresponding to the second number of phases which are those lines preselected from the number of signal lines corresponding to the first number of phases.

A tenth aspect of the present invention provides the liquid crystal display apparatus according to the ninth aspect of the present invention, further including:

a first switch circuit for making an electric connection of the first liquid crystal panel with the preselected signal lines when the first analog image signal is outputted from the output section, and for making an electric separation of the first liquid crystal panel from the preselected signal lines when the second analog image signal is outputted from the output section; and

a second switch circuit for making an electric separation of the second liquid crystal panel from the preselected signal lines when the first analog image signal is outputted from the output section, and for making an electric connection of the second liquid crystal panel with the preselected signal lines when the second analog image signal is outputted from the output section.

An eleventh aspect of the present invention provides a liquid crystal display apparatus which utilizes a driver monolithic liquid crystal panel including: a plurality of pixel formation sections for forming an image to be displayed; a plurality of data signal lines for sending signals representing the image to be displayed to the pixel formation sections; and a data signal line drive circuit for driving the data signal lines in dot sequential drive method by sequential application to the data signal lines of image signals inputted as a representation of the image to be displayed. The apparatus includes:

a first liquid crystal panel categorized as the driver monolithic liquid crystal panel, for displaying an image based on an image signal processed through phase expansion into a first number of phases;

a second liquid crystal panel categorized as the driver monolithic liquid crystal panel, for displaying an image based on an image signal processed through phase expansion into a second number of phases that is smaller than the first number of phases;

a phase expansion section for generating a digital image signal from image data inputted as a representation of the image to be displayed, through phase-expansion into the first number of phases;

an output section for outputting an image signal which is equivalent to the digital image signal generated by the phase expansion section; and

a number of signal lines corresponding to the first number of phases, for sending the image signal outputted from the output section to the first liquid crystal panel.

With the above, the image signal outputted from the output section for display of an image on the second liquid crystal panel is sent to the second liquid crystal panel by a number of signal lines corresponding to the second number of phases which are those lines preselected from the number of signal lines corresponding to the first number of phases.

A twelfth aspect of the present invention provides the liquid crystal display apparatus according to the eleventh aspect of the present invention, further including a memory for storing the image data:

The phase expansion section generates a phase-expanded digital image signal by reading and processing the image data from the memory at a speed corresponding to the first number of phases.

A thirteenth aspect of the present invention provides the liquid crystal display apparatus according to the eleventh aspect of the present invention, further including

a memory for storing the image data:

The phase-expansion section is provided by a read controlling section which reads the image data from the memory so that data read from the memory in a form of a signal provides the phase-expanded digital image signal.

A fourteenth aspect of the present invention provides the liquid crystal display apparatus according to one of the eleventh through thirteenth aspects of the present invention, further including a switching section for switching the image signal outputted from the output section between an image signal for display of an image on the first liquid crystal panel and an image signal for display of an image on the second liquid crystal panel.

A fifteenth aspect of the present invention provides the liquid crystal display apparatus according to the fourteenth aspect of the present invention, further including

a conversion section for converting the digital image signal generated by the phase expansion section into an analog image signal:

The output section

includes a number of buffers corresponding to the first number of phases for outputting the analog image signal to said number of the signal lines corresponding to the first number of phases, and

outputs the analog image signal, if the image signal outputted from the output section is for display of an image on the second liquid crystal panel, to the preselected lines via a number of buffers corresponding to the second number of phases which are those buffers preselected from the number of buffers corresponding to the first number of phases.

A sixteenth aspect of the present invention provides the liquid crystal display apparatus according to the fifteenth aspect of the present invention, further including

a buffer control section for stopping operation of the other buffers than those preselected from the number of buffers corresponding to the first number of phases when the analog image signal outputted from the output section is for display of an image on the second liquid crystal panel.

A seventeenth aspect of the present invention provides the liquid crystal display apparatus according to the fourteenth aspect of the present invention, further including:

a first switch circuit for making an electric connection of the first liquid crystal panel with the preselected signal lines when the image signal outputted from the output section is for display of an image on the first liquid crystal, and for making an electric separation of the first liquid crystal panel from the preselected signal lines when the image signal outputted from the output section is for display of an image on the second liquid crystal; and

a second switch circuit for making an electric separation of the second liquid crystal panel from the preselected signal lines when the image signal outputted from the output section is for display of an image on the first liquid crystal, and for making an electric connection of the second liquid crystal panel with the preselected signal lines when the image signal outputted from the output section is for display of an image on the second liquid crystal.

### ADVANTAGES OF THE INVENTION

According to the first aspect of the present invention, the liquid crystal panel drive circuit is capable of outputting any of at least two kinds of phase expansion signals or any of the first and the second phase-expansion signals in response to switching made by the switching section, based on image data, i.e. the data representing the image to be displayed. This means that one liquid crystal panel drive circuit is able to drive a plurality of liquid crystal panels of different sizes each requiring a phase expansion process of a different number of phases from each other. By using such a liquid crystal panel drive circuit in a liquid crystal display apparatus which has two liquid crystal panels (typically, two liquid crystal panels each having a different size from the other) each requiring a phase expansion process of a number of phases different from the number of phases in the other, it becomes possible to decrease circuit size of the liquid crystal display apparatus. Further, when the present invention is applied to a liquid crystal display apparatus which has only one liquid crystal panel, the present invention provides a versatility advantage that the liquid crystal panel drive circuit can be used in at least two kinds of liquid crystal display apparatuses, i.e. one with a liquid crystal panel requiring one type of phase expansion process and the other requiring another type of phase expansion process.

According to the second aspect of the present invention, image data which represents an image to be displayed is read from the memory at a speed corresponding to the first or the second number of phases in the process of phase expansion, whereby at least two kinds or both phase expansion signals, i.e. the first and the second phase-expansion signals, are obtained. This enables to reduce circuit size in liquid crystal display apparatuses which have two liquid crystal panels each requiring a different phase expansion process from the other. Further, sharing of the memory, which is a part that occupies a large area, by these liquid crystal panels offers a remarkable advantage in the circuit size reduction.

According to the third aspect of the present invention, at least two kinds of phase expansion signals, i.e. the first and the second phase-expansion signals, are obtained by controlling the reading of the image data from the memory which stores the image data representing the image to be displayed. This enables to reduce circuit size in liquid crystal display apparatuses which have two liquid crystal panels each requiring a different phase expansion process from the other. Further, sharing of the memory, which is a part that occupies a large area, by these liquid crystal panels offers a remarkable advantage in the circuit size reduction.

According to the fourth aspect of the present invention, the liquid crystal panel drive circuit is able to output analog image signals which are equivalent to at least two kinds of phase expansion signals, i.e. the first and the second analog image signals, as image signals to be supplied to the driver monolithic liquid crystal panel (to the data drive circuit therein). This enables to reduce circuit size in liquid crystal display apparatuses which have two analog driver monolithic liquid crystal panels each requiring a different phase expansion process from the other.

According to the fifth aspect of the present invention, operation of the output buffer section for the first or the second analog image signal which is not outputted from the output section is stopped. This enables to reduce power consumption by the liquid crystal panel drive circuit.

According to the sixth aspect of the present invention, sharing is made in the output section, on the buffers for the first analog image signal and the buffers for the second analog image signal. This enables to further reduce the circuit size in the liquid crystal panel drive circuit and the liquid crystal display apparatuses using the same.

According to the seventh aspect of the present invention, when the output section outputs the second analog image signal which represents the second phase-expansion signal having a smaller number of phases, operation of those buffers in the output section which do not serve the second analog image signal is stopped. This enables to reduce power consumption by the liquid crystal panel drive circuit.

According to the eighth aspect of the present invention, the same advantages as in the first through the fifth aspects of the present invention are offered in liquid crystal display apparatuses which have two liquid crystal panels each requiring a different phase expansion process from the other.

According to the ninth aspect of the present invention, the same advantages as in the sixth or the seventh aspect of the present invention are offered in liquid crystal display apparatuses which have two driver monolithic liquid crystal panels each requiring a different phase expansion process from the other.

According to the tenth aspect of the present invention, those of the signal lines which are to send the analog image signal outputted from the liquid crystal panel drive circuit to the first and the second liquid crystal panels and which are shared by the first and the second liquid crystal panels are electrically disconnected from the non-operating one of the first and the second liquid crystal panels. This reduces the load on the buffers which output the analog image signal to the shared signal lines. This enables to reduce an increase in power consumption of the liquid crystal panel drive circuit by way of non-dependence upon special high-performance buffers while decreasing the circuit size by way of sharing buffers and signal transmission lines for the analog image signals.

According to the eleventh aspect of the present invention, a single phase-expansion section generates a phase expansion signal, and an image signal equivalent thereto is sent from the liquid crystal panel drive circuit to the first liquid crystal panel via signal lines: Of these signal lines, those preselected signal lines corresponding to the second number of phases supply the second liquid crystal panel with an image signal for display of an image on the second liquid crystal panel. This enables to reduce circuit size in liquid crystal display apparatuses which have two liquid crystal panels or the first and the second liquid crystal panels.

According to the twelfth aspect of the present invention, image data which represent an image to be displayed are read from the memory at a speed corresponding to the first number of phases and processed through phase expansion to become a phase expansion signal, and an image signal equivalent to this phase expansion signal is sent to the first and the second liquid crystal panels. This enables to reduce circuit size in liquid crystal display apparatuses which have two liquid crystal panels or the first and the second liquid crystal panels. Further, sharing of the memory, which is a part that occupies a large area, by these liquid crystal panels offers a remarkable advantage in the circuit size reduction.

According to the thirteenth aspect of the present invention, a phase expansion signal is obtained by controlling the reading of the image data from the memory which stores the image data representing an image to be displayed, and an image signal equivalent to this phase expansion signal is sent to the first and the second liquid crystal panels. This enables to reduce circuit size in liquid crystal display apparatuses which have two liquid crystal panels, i.e. the first and the second liquid crystal panel. Further, sharing of the memory, which is a part that occupies a large area, by these liquid crystal panels offers a remarkable advantage in the circuit size reduction.

According to the fourteenth aspect of the present invention, switching is made to the image signal which is outputted from the output section, between an image signal for display of an image on the first liquid crystal panel and an image signal for display of an image on the second liquid crystal panel. This enables a single liquid crystal panel drive circuit to display images on the first and the second liquid crystal panels. This enables to reduce circuit size in liquid crystal display apparatuses which have these two liquid crystal panels.

According to the fifteenth aspect of the present invention, sharing is made in the output section on the buffers for outputting analog image signals for display of an image on the first liquid crystal panel and the buffers for outputting analog image signals for display of an image on the second liquid crystal panel. This enables to reduce circuit size in liquid crystal display apparatuses which includes two analog driver monolithic liquid crystal panels.

According to the sixteenth aspect of the present invention, when the output section outputs an analog image signal for display of an image on the second liquid crystal panel which requires a phase expansion process of a smaller number of phases, operation of those buffers in the output section which do not serve said analog image signal is stopped. This enables to reduce power consumption by the liquid crystal panel drive circuit.

According to the seventeenth aspect of the present invention, the same advantages are offered as according to the tenth aspect of the present invention.

### BRIEF DESCRIPTION OF THE DRAWINGS

FIG. 1 is a block diagram showing an overall configuration of a liquid crystal display apparatus according to a first embodiment of the present invention.

FIG. 2 is a conceptual diagram for describing a connection relationship of a liquid crystal panel drive circuit with a main panel and a sub panel, according to the first embodiment.

FIG. 3 is a block diagram showing a configuration of the liquid crystal panel drive circuit according to the first embodiment.

FIG. 4 is a block diagram showing a configuration of an image memory section according to the first embodiment.

FIG. 5A is a signal waveform chart for describing a 2-phase expansion process according to the first embodiment.

FIG. 5B is a signal waveform chart for describing a 1-phase expansion process according to the first embodiment.

FIG. 6 is a diagram for describing a buffer control signal for controlling an analog output buffer section of the liquid crystal panel drive circuit according to the first embodiment.

FIG. 7 is a schematic diagram for describing a connection relationship of a liquid crystal panel drive circuit with a main panel and a sub panel, according to a second embodiment of the present invention.

FIG. 8 is a block diagram showing a configuration of the liquid crystal panel drive circuit according to the second embodiment.

FIG. 9 is a block diagram showing a configuration of an image memory section according to the second embodiment.

FIG. 10 is a diagram for describing a buffer control signal for controlling an analog output buffer section of the liquid crystal panel drive circuit according to the second embodiment.

FIG. 11 is a circuit diagram showing a configuration of a switch circuit for reducing a load on the analog output buffer section in the liquid crystal panel drive circuit according the second embodiment.

FIG. 12 is a diagram for describing an operation of the switch circuit for reducing a load on the analog output buffer section in the liquid crystal panel drive circuit according the second embodiment.

FIG. 13 is a block diagram showing a configuration of a liquid crystal panel drive circuit according to a variation of the first embodiment.

FIG. 14 is a block diagram showing a configuration of a liquid crystal panel drive circuit according to a variation of the second embodiment.

FIG. 15 is a simplified block diagram of a conventional liquid crystal display apparatus provided with a plurality of liquid crystal panels.

FIG. 16 is a diagram for describing phase expansion.

### LEGEND

2 . . . Phase switching section
3 . . . Read controlling section
21 . . . Timing generator section
22 . . . Host interface section
23 . . . Image memory section
230 . . . Memory
231, 233 . . . Switching output sections
232, 234 . . . Buffer sections
24 . . . Phase expansion section
241 . . . First phase expansion section
242 . . . Second phase expansion section
25 . . . Gamma conversion section
26 . . . D/A conversion section
27 . . . Analog output section
271 . . . First output buffer section
272 . . . Second output buffer section
200 . . . Liquid crystal panel drive circuit
300 . . . Source driver
400 . . . Gate driver
500 . . . Display section
610 . . . First liquid crystal panel
620 . . . Second liquid crystal panel
612, 622 . . . Switch circuits
R1M, G1M, B1M, R2M, G2M, B2M . . . Video signal lines
R1S, G1S, B1S . . . Video signal lines
R1, G1, B1 . . . . Video signal lines
R2, G2, B2 . . . Video signal lines
PS . . . Panel indication signal
SB1, SB2 . . . Buffer control signals
SW1, SW2 . . . Switch control signals

### BEST MODE FOR CARRYING OUT THE INVENTION

Hereinafter, embodiments of the present invention will be described with reference to the attached drawings.

### 1. First Embodiment

<1.1 Overall Configuration and Operation>

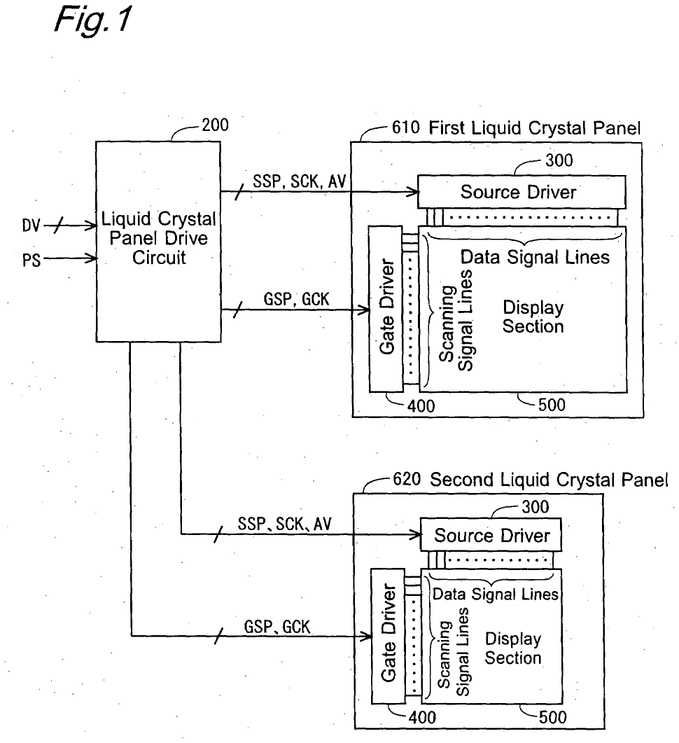

FIG. 1 is a block diagram which shows an overall configuration of a liquid crystal display apparatus according to a first embodiment of the present invention. The liquid crystal display apparatus includes a liquid crystal panel drive circuit 200, a first liquid crystal panel 610 and a second liquid crystal panel 620. Each of the first liquid crystal panel 610 and the second liquid crystal panel 620 includes a source driver 300, a gate driver 400, and a display section 500. Further, the display section 500 includes a plurality of data signal lines connected with the source driver 300, a plurality of scanning signal lines connected with the gate driver 400, and a plurality of pixel formation sections (not illustrated) provided correspondingly to respective intersections made by the data signal lines and the scanning signal lines. It should be noted here that the first liquid crystal panel 610 in the present embodiment is commonly called “main panel” whereas the second liquid crystal panel 620 is commonly called “sub panel”. More specifically, the display section 500 in the first liquid crystal panel 610 has a size greater than that of the display section 500 in the second liquid crystal panel 620, and accordingly, the display section 500 in the first liquid crystal panel 610 has more data signal lines, more scanning signal lines, and more pixel formation sections than those of the display section 500 in the second liquid crystal panel 620. With these arrangements, the first liquid crystal panel 610 displays images based on 2-phase expansion signals whereas the second liquid crystal panel 620 displays images based on 1-phase expansion signals. The first and the second liquid crystal panels 610, 620 do not make their display simultaneously with each other; and in order to choose a liquid crystal panel which is supposed to do display, switching is made between these two liquid crystal panels 610, 620. For this reason, the present embodiment provides only one liquid crystal panel drive circuit 200 as the drive circuit for these two liquid crystal panels 610, 620. Of these liquid crystal panels 610, 620, one which is not supposed to do display is not supplied with power so as to avoid unnecessary power consumption.

The liquid crystal panel drive circuit 200 receives a digital image signal DV and a panel indication signal PS from outside, and outputs the following signals for causing a display of an image represented by the digital image signal DV, on the display section 500 of the first liquid crystal panel 610 or of the second liquid crystal panel 620 selected by the panel indication signal PS. Those signals are: a source start pulse signal SSP, a source clock signal SCK, an analog video signal AV, a gate start pulse signal GSP and a gate clock signal GCK. The source driver 300 receives the source start pulse signal SSP, the source clock signal SCK and the analog video signal AV outputted from the liquid crystal panel drive circuit 200, and makes sequential application of the analog video signal AV to each data signal line based on the source start pulse signal SSP and the source clock signal SCK. As described, the source driver 300 makes so called dot sequential drive. The gate driver 400 receives the gate start pulse signal GSP and the gate clock signal GCK outputted from the liquid crystal panel drive circuit 200, and allows sequential selection of each scanning signal line per horizontal scanning period by repeating application of an active scanning signal to a scanning signal line based on the gate start pulse signal GSP and the gate clock signal GCK during each cycle of a vertical scanning period. With the above, the analog video signal AV is applied to each data signal line and the scanning signal is applied to each scanning signal line, completing a display of an image on the display section 500.

It should be noted that the source start pulse signal SSP, the source clock signal SCK, the analog video signal AV, the gate start pulse signal GSP and the gate clock signal GCK supplied to the first liquid crystal panel 610 are not the same signals as those signals supplied to the second liquid crystal panel 620. The difference is based on differences between the first liquid crystal panel 610 and the second liquid crystal panel 620 in terms of the number of data signal lines, the number of scanning signal lines, the number of pixel formation sections and the number of phases in the phase expansion signals inputted to the source driver 300 as the analog video signal. For the sake of descriptive convenience however, no notational differentiation will be made for the signals SSP, SCK, AV, GSP, GCK between the first liquid crystal panel and the second liquid crystal panel in the present description. As another note, the first and the second liquid crystal panels 610, 620 have common electrodes provided commonly to the above-mentioned pixel formation sections, and the liquid crystal panels 610, 620 are supplied with a common electrode signal which is the signal for driving the common electrodes. Further, there must be a power supply for driving these first and second liquid crystal panels 610, 620. However, none of these will be described in the present description since these common electrodes, power source etc., have no direct relationship with the present invention.

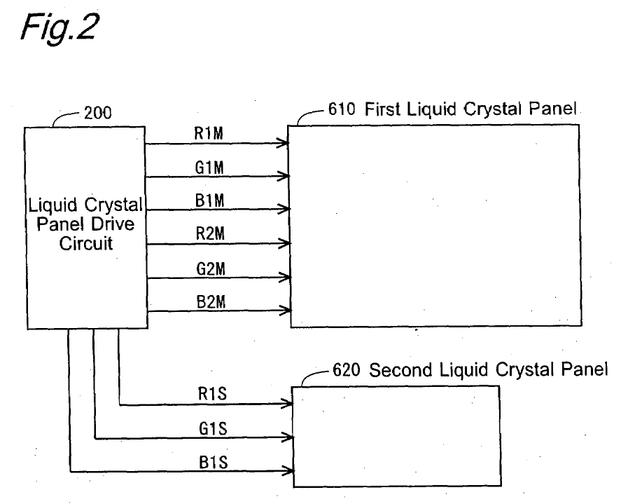

FIG. 2 is a block diagram for describing a connection relationship provided by video signal lines in order to send the analog video signal AV from the liquid crystal panel drive circuit 200 to the first liquid crystal panel 610 as well as to the second liquid crystal panel 620. As described above, the first liquid crystal panel 610 displays images based on 2-phase expansion signals while the second liquid crystal panel 620 displays images based on 1-phase expansion signals. Therefore, the first liquid crystal panel 610 must be supplied with 2-phase expansion signals while the second liquid crystal panel 620 must be supplied with 1-phase expansion signals. Thus, for the first liquid crystal panel 610, the liquid crystal panel drive circuit 200 performs a 2-phase expansion process, a D/A conversion process, etc. for each of the R (red), G (green), B (blue) colors, to generate specific analog video signal AV. Accordingly, the first liquid crystal panel 610 and the liquid crystal panel drive circuit 200 are connected with each other by six video signal lines R1M, G1M, B1M, R2M, G2M, and B2M. On the other hand, for the second liquid crystal panel 610, the liquid crystal panel drive circuit 200 performs a 1-phase expansion process, a D/A conversion process, etc.; to generate a specific analog video signal AV. Therefore, the second liquid crystal panel 620 and the liquid crystal panel drive circuit 200 are connected with each other by three video signal lines R1S, G1S, and B1S.

<1.2 Configuration and Operation of Liquid Crystal Panel Drive Circuit>

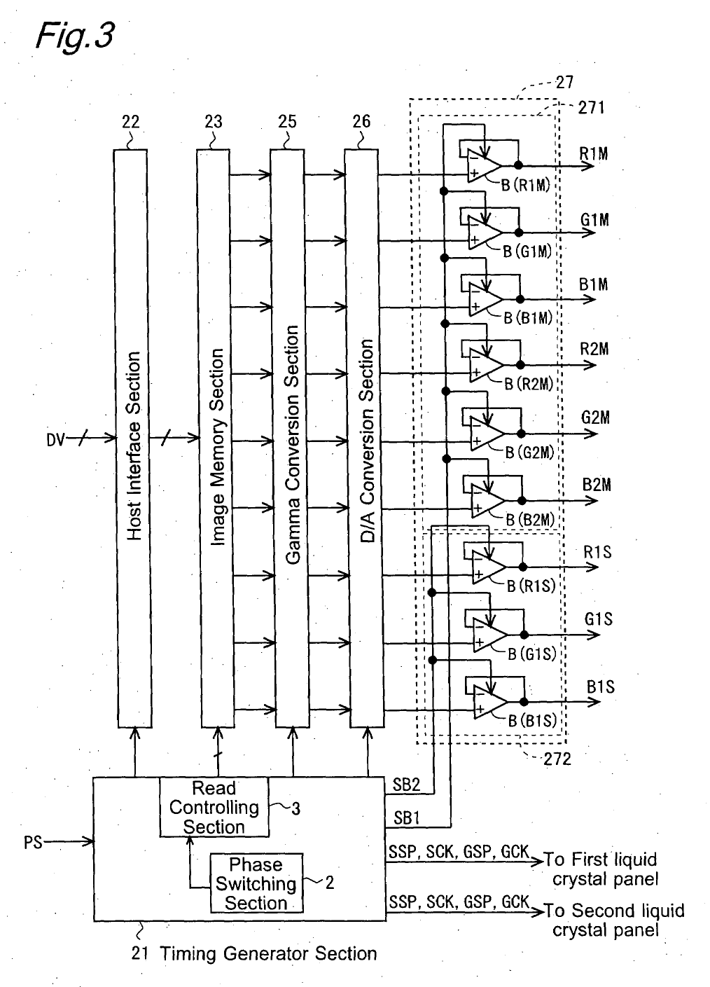

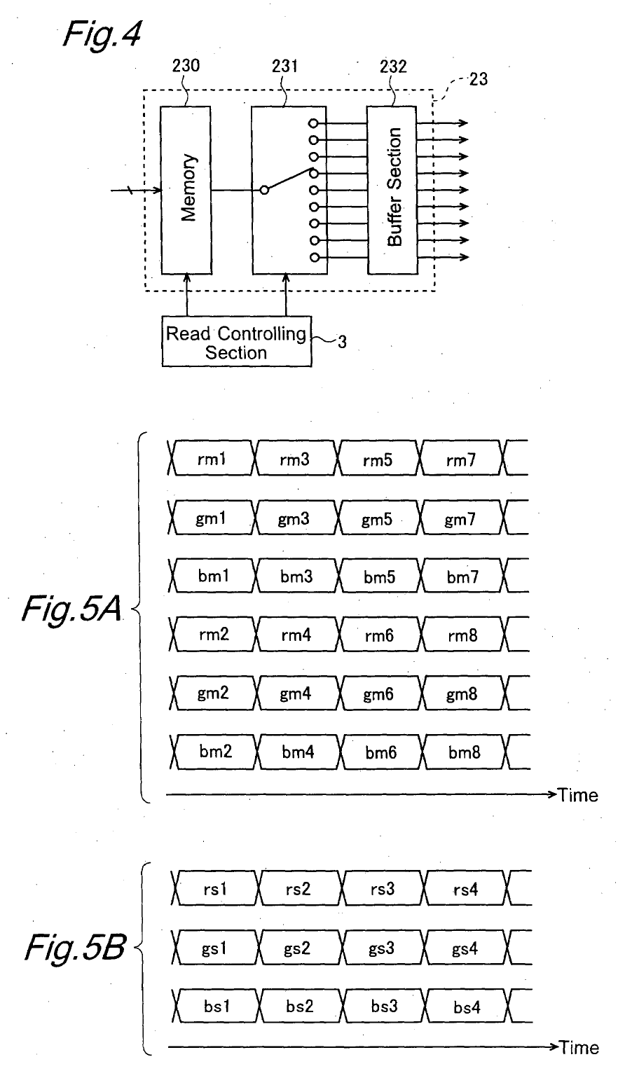

Next, description will cover detailed configuration and operation of the liquid crystal panel drive circuit 200 according to the present embodiment. FIG. 3 is a block diagram showing the configuration of the liquid crystal panel drive circuit 200. The liquid crystal panel drive circuit 200 includes a timing generator section 21, a host interface section 22, an image memory section 23, a gamma conversion section 25, a D/A conversion section 26 and an analog output section 27. Also, as shown in FIG. 4, the image memory section 23 includes a memory 230, a switching output section 231 and a buffer section 232. FIG. 4 is a block diagram which shows a configuration of the image memory section 23.

The timing generator section 21 includes a phase switching section 2 for switching the mode of component operation in the liquid crystal panel drive circuit 200 in accordance with the size of a selected one of the first and the second liquid crystal panels 610, 620 (hereinafter “working panel”) chosen by the panel indication signal PS as a liquid crystal panel which is supposed to do the display. The timing generator section 21 also includes a read controlling section 3 to generate an address signal and a control signal for a reading operation from the image memory section 23 of image data which represent images to be displayed on the working panel. The operation of the read controlling section 3 is switched, also by the phase switching section 2.

The analog output section 27 includes two output buffer sections: The first output buffer section 271 has a set of three buffers B(R1M), B(G1M), B(B1M) for outputting a first-phase portion of the analog video signal AV which is an analog video signal AV to be supplied to the first liquid crystal panel 610 (i.e. the source driver 300 therein), and another set of three buffers B(R2M), B(G2M), B(B2M) for outputting a second-phase portion of the analog video signal AV which is an analog video signal AV to be supplied to the first liquid crystal panel 610; the second output buffer section 272 has a set of three buffers B (R1S), B (G1S), B (B1S) for outputting the analog video signal AV to be supplied to the second liquid crystal panel 610. Each of the buffers in the present embodiment is provided by a voltage follower (as also is in the other embodiments).

The timing generator section 21 receives the panel indication signal PS, and generates the earlier-mentioned source start pulse signal SSP, source clock signal SCK, gate start pulse signal GSP, and gate clock signal GCK so that the image will be displayed at appropriate timing on the display section 500 of the liquid crystal panel, as well as generating a timing signal for the host interface section 22, the gamma conversion section 25 and the D/A conversion section 26 to work at appropriate timing. The phase switching section 2 in the timing generator section 21 generates a first buffer control signal SB1 and a second buffer control signal SB2 based on the panel indication signal PS, for output control of the analog video signal AV to each of the liquid crystal panels 610, 620.

The host interface section 22 receives the digital image signal DV from outside, and stores the digital image signal DV in the image memory section 23 as image data.

The read controlling section 3 in the timing generator section 21, which works under the control of phase switching section 2, reads the image data from the image memory section 23 in accordance with the number of phases of the analog video signal AV, i.e. the number of phases in the phase expansion signal to be supplied to the working panel (to the source driver 300 therein), and outputs the data as a digital image signal in the form of phase expansion signal. Hereinafter, operations of the read controlling section 3 and the image memory section 23 will be described in detail.

First, the read controlling section 3 outputs an address signal to the memory 230 at a speed (time interval) corresponding to the phase expansion. Specifically, in 1-phase expansion (i.e. when the second liquid crystal panel 620 is to display an image), the read controlling section 3 outputs the address signal to the memory 230 at a first speed. On the other hand, in 2-phase expansion (i.e. when the first liquid crystal panel 610 is to display an image), the read controlling section 3 outputs the address signal to the memory 230 at a second speed which is a speed faster than the first speed. Thus, the image data in the memory 230 is read as a digital image signal by the switching output section 231 at a speed corresponding to the phase expansion. It should be noted here that the signal which is read from the memory 230 and represents image data has a bit-width appropriate for the number of halftones for the display (For example, the signal is a 6-bit signal if display is to be made in 64 tones). For simplicity, however, description hereinafter will be made as if the signal were sent/received through a single line.

Upon reception of the digital image signal, the switching output section 231 outputs the digital image signal to a plurality of signal lines while switching between these lines. Specifically, the read controlling section 3 outputs to the switching output section 231 a switching control signal for changing the connection relationship between the output signal line of the memory 230 and the above-mentioned plurality of signal lines. More specifically, in 2-phase expansion, the switching control signal is a signal which causes sequential switching in the connection of the output-side signal line of the memory 230 with one of the upper six signal lines which go into the first liquid crystal panel 610. In 1-phase expansion, the switching control signal is a signal which causes sequential switching in the connection of the output-side signal line of the memory 230 with one of the lower three signal lines which go into the second liquid crystal panel 620. The buffer section 232 receives all the digital image signals outputted sequentially from the switching output section 231 via the signal lines, and output these signals simultaneously. Thus, in 2-phase expansion, the buffer section 232 receives digital image signals which are sent sequentially from the switching output section 231 via the upper six signal lines, and outputs all of these digital image signals to the gamma conversion section 25 at a single timing. In 1-phase expansion on the other hand, the buffer section 232 receives digital image signals which are sent sequentially from the switching output section 231 via the lower three signal lines, and outputs all of these digital image signals to the gamma conversion section 25 at a single timing. Thus, when the panel indication signal PS sent from outside indicates that the image should be displayed on the first liquid crystal panel 610 (that the first liquid crystal panel 610 should be the working panel), the output is as shown in FIG. 5A, i.e. digital image signals resulted from the 2-phase expansion operation is outputted from the image memory section 23. On the other hand, when the panel indication signal PS sent from outside indicates that the image should be displayed on the second liquid crystal panel 620 (that the second liquid crystal panel 620 should be the working panel) the output is as shown in FIG. 5B, i.e. digital image signals resulted from the 1-phase expansion operation is outputted from the image memory section 23. It should be noted that symbols “rmj”, “gmj” and “bmj” in FIG. 5A indicate values of R (red), G (green), B (blue) in the j-th pixel of an image to be displayed in the first liquid crystal panel 610. Symbols “rsj”, “gsj” and “bsj” in FIG. 5B indicate values of R (red), G (green), B (blue) in the j-th pixel of an image to be displayed in the second liquid crystal panel 620 (Note also that each value for R (red), G (green), B (blue) in each pixel is illustrated as a 1-bit signal for simplicity; actually however, the values are multi-bit signals appropriate to the number of halftones).

As will be understood from the above description, according to the present embodiment, phase expansion means (the first phase-expansion section for 2-phase expansion, and the second expansion section for 1-phase expansion) is provided by the switching output section 231, the buffer section 232 and the read controlling section 3, provided that the image memory section 23 includes the memory 230.

Generally, if the size of liquid crystal panel increases, the number of pixels per frame increases accordingly, and the signal duration per pixel becomes shorter. However, by performing the above-described phase expansion (or by increasing the number of phases in the phase expansion), it becomes possible to increase the signal duration per pixel. As described above, the present embodiment provides an arrangement that a large-sized first liquid crystal panel 610 is supplied with an analog video signal made from a specific digital image signal prepared accordingly, i.e. an image signal processed in 2-phase expansion as shown in FIG. 5A whereas a small-sized second liquid crystal panel 610 is supplied with an analog video signal made from a specific digital image signal prepared accordingly, i.e. an image signal which is processed in 1-phase expansion, or is not processed in phase expansion as shown in FIG. 5B. Under this arrangement, even if liquid crystal panels have different sizes, a difference in terms of signal duration per pixel does not become very large.

The gamma conversion section 25 performs a gamma conversion process to the digital image signal, i.e. the phase expansion signal outputted from the image memory section 23, for appropriate halftone in the display to be made on the display section 500 of the liquid crystal panel. After the gamma conversion process, the D/A conversion section 26 converts the digital signal into an analog signal, and outputs the signal as an analog video signal AV. The analog output section 27 supplies the analog video signal AV to one of the first liquid crystal panel 610 and the second liquid crystal panel 620, depending on the first buffer control signal SB1 and the second buffer control signal SB2 which are given by the phase switching section 2. The gamma conversion process and the D/A conversion process are already public, and details will not be described here.

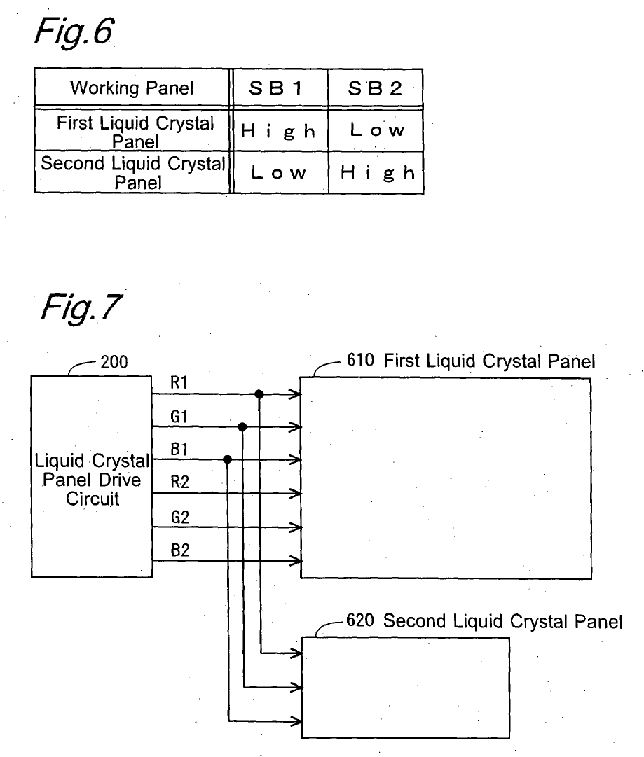

Next, more detailed description will be made for the operation of the analog output section 27. Of the buffers included in the analog output section 27, the buffers B(R1M), B (G1M), B (B1M), B (R2M), B (G2M) and B (B2M) constitute the first output buffer section 271 which is a section for supplying the first liquid crystal panel 610 with the analog video signal AV as a 2-phase expansion signal, and these buffers are switched by a first buffer control signal SB1 to take an operating state or a non-operating state. On the other hand, the buffers B(R1S), B(G1S) and B(B1S) constitute the second output buffer section 272 for supplying the second liquid crystal panel 620 with the analog video signal AV as a 1-phase signal, and these buffers are switched by a second buffer control signal SB2, to take an operating state or a non-operating state. Each of the buffers takes the operating state, i.e. functions as a voltage follower, and outputs the analog video signal AV when the buffer control signal assumes HIGH level. On the other hand, when the buffer control signal assumes LOW level, the buffer takes the non-operating state, i.e. stops the output of analog video signal AV. FIG. 6 is a diagram illustrating the states of the first buffer control signal SB1 and the second buffer control signal SB2. When the first liquid crystal panel 610 is the working panel, the first buffer control signal SB1 assumes HIGH level whereas the second buffer control signal SB2 assumes LOW level. On the other hand, when the second liquid crystal panel 620 is the working panel, the first buffer control signal SB1 assumes LOW level and the second buffer control signal SB2 assumes HIGH level. By giving the first buffer control signal SB1 and the second buffer control signal SB2 as described, from the phase switching section 2 to the analog output section 27, only those buffers operate which are supposed to supply the analog video signal AV to the working panel that is selected from the first and the second liquid crystal panels 610, 620, while the other buffers stop their operation.

<1.3 Function and Advantages>

According to the present embodiment, a digital image signal DV supplied from outside of the liquid crystal display apparatus is stored as an image data, in the image memory section 23 of the liquid crystal panel drive circuit 200 which is the only one liquid crystal panel drive circuit provided in the liquid crystal display apparatus regardless of whether the working panel is the first liquid crystal panel 610 or the second liquid crystal panel 620. Then, in accordance with the size of the working panel, the liquid crystal panel drive circuit 200 performs a phase expansion process. After the phase expansion process, D/A conversion process, etc., a resulting analog video signal AV is supplied from the analog output section 27 in the liquid crystal panel drive circuit 200 to the working panel (to the source driver 300 thereof), for display of the image on the display section 500 in the working panel.

As has been described above, in a liquid crystal display apparatus which has two liquid crystal panel of different sizes, one liquid crystal panel drive circuit 200 controls the two liquid crystal panels while switching is made as to which of the panels to work on. In the operation, the liquid crystal panel drive circuit 200 uses the digital image data stored in its image memory section 23 for phase expansion: When driving the first liquid crystal panel 610 a 2-phase expansion process is performed to the data whereas when driving the second liquid crystal panel 620, a 1-phase expansion process is performed. Conventionally, when a liquid crystal display apparatus includes a plurality of liquid crystal panels which need phase expansion processes of different number of phases, it was necessary to provide a plurality of liquid crystal panel drive circuits 200 in order to drive these different liquid crystal panels. However, according to the present embodiment, only one liquid crystal panel drive circuit (e.g. one IC (Integrated Circuit) chip as a liquid crystal panel drive circuit) is needed as described above. This enables to reduce the circuit size as compared to conventional liquid crystal display apparatuses which have two liquid crystal panels of different sizes. In particular, the image memory section 23 in the liquid crystal panel drive circuit 200 stores all image data necessary for the first liquid crystal panel 610 and the second liquid crystal panel 620, according to the present embodiment. Sharing of the memory, which is apart that occupies a large area in the circuit, between the first liquid crystal panel 610 and the second liquid crystal panel offers a great advantage in circuit size reduction, providing benefits in size reduction of the liquid crystal display apparatuses.

Conventionally, when a liquid crystal display apparatus includes a plurality of liquid crystal panels which need phase expansion processes of different number of phases, it was necessary to provide a plurality of liquid crystal panel drive circuits in order to drive these different liquid crystal panels, and this meant that a liquid crystal panel drive circuit must be designed for each of the liquid crystal panels. However, the present embodiment which only requires a single liquid crystal panel drive circuit as described above, reduces the burden in designing.

The present embodiment, which provides reduction in circuit size and reduction in burden of designing, enables to reduce cost in manufacture and development of liquid crystal display apparatuses.

Still further, according to the present embodiment, those buffers in the analog output section 27 which are not operating to supply the working panel with analog video signal AV assume a non-operating state. Since buffers in the analog output section 27 consume a large amount of power in general, the arrangement according to the present embodiment, i.e. not driving unnecessary buffers, helps reduce power consumption in the liquid crystal display apparatus and the liquid crystal panel drive circuit 200.

### 2. Second Embodiment

<2.1 Overall Configuration, etc.>

Next, a second embodiment of the present invention will be described. The present embodiment uses the same overall configuration as used in the first embodiment illustrated in FIG. 1, so the same or corresponding portions will be indicated by the same reference symbols, with their details not described here again. FIG. 7 is a block diagram for describing a connection relationship provided by video signal lines in order to send an analog video signal AV from the liquid crystal panel drive circuit 200 to the first liquid crystal panel 610 as well as to the second liquid crystal panel 620. Like in the first embodiment, the first liquid crystal panel 610 requires a supply of 2-phase expansion signals while the second liquid crystal panel 620 requires a supply of 1-phase expansion signals in the present embodiment, in order to make appropriate display of images on the display section 500. In the first embodiment, as shown in FIG. 2, the liquid crystal panel drive circuit 200 has nine video signal lines; of these, six video signal lines are connected with the first liquid crystal panel 610 and the remaining three video signal lines are connected with the second liquid crystal panel 620. On the contrary, in the present embodiment, the liquid crystal panel drive circuit 200 has six video signal lines R1, G1, B1, R2, G2, and B2; of these, three video signal lines R1, G1, and B1 are connected with the first liquid crystal panel 610 and with the second liquid crystal panel 620. In other words, three video signal lines of the six video signal lines are shared between the first liquid crystal panel 610 and the second liquid crystal panel 620. The other three video signal lines R2, G2, and B2 which go to the liquid crystal panel drive circuit 200 are connected with the first liquid crystal panel 610.

<2.2 Configuration and Operation of Liquid Crystal Panel Drive Circuit>

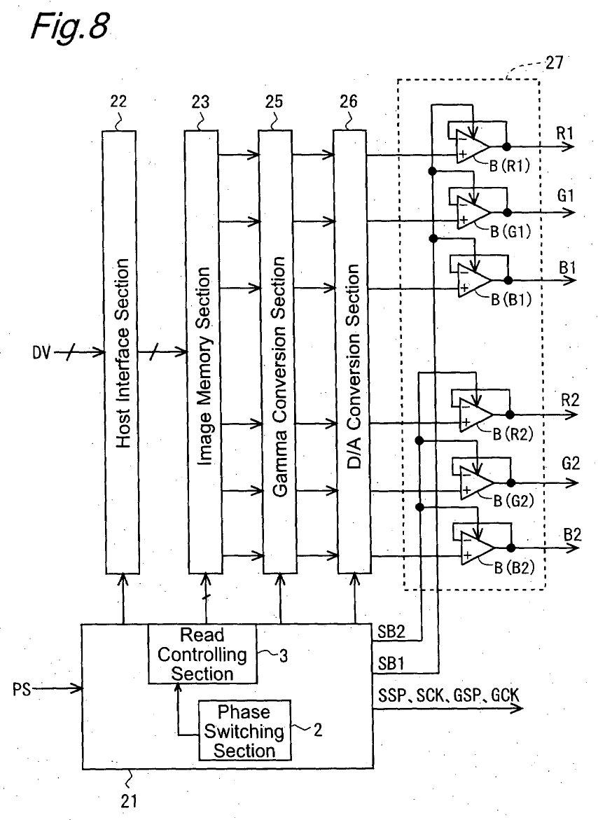

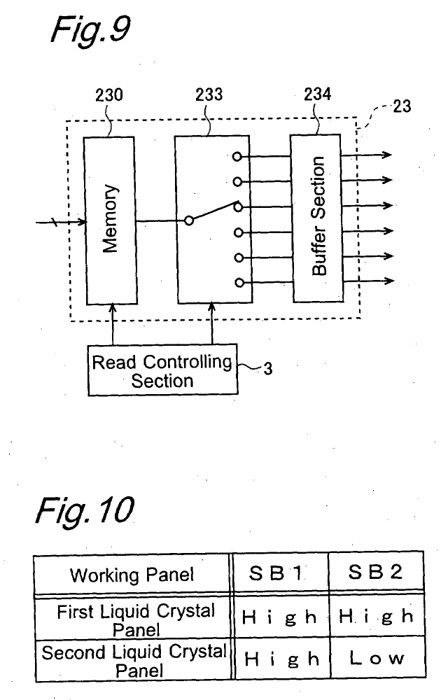

Next, description will cover detailed configuration and operation of the liquid crystal panel drive circuit 200 according to the present embodiment. FIG. 8 is a block diagram showing the configuration of the liquid crystal panel drive circuit 200. The liquid crystal panel drive circuit 200 includes a timing generator section 21, a host interface section 22, an image memory section 23, a gamma conversion section 25, a D/A conversion section 26 and an analog output section 27. Also, as shown in FIG. 9, the image memory section 23 includes a memory 230, a switching output section 233 and a buffer section 234. FIG. 9 is a block diagram which shows a configuration of the image memory section 23.

The timing generator section 21 includes a phase switching section 2 for switching the mode of component operation in the liquid crystal panel drive circuit 200 in accordance with the size of the working panel chosen by the panel indication signal PS. The timing generator section 21 also includes a read controlling section 3 to generate an address signal and a control signal for a reading operation from the image memory section 23 of image data which represent images to be displayed on the working panel. The operation of the read controlling section 3 is switched, also by the phase switching section 2. Thus, as in the first embodiment, 2-phase expansion signals are generated from image data read from the image memory section 23 when the first liquid crystal panel 610 is the working panel whereas when the second liquid crystal panel 620 is the working panel, 1-phase expansion signals generated from the image data read from the image memory section 23. Specifically, first, the read controlling section 3 outputs an address signal to the memory 230 at a speed (time interval) corresponding to the phase expansion. Specifically, in 1-phase expansion (i.e. when the second liquid crystal panel 620 is to display an image), the read controlling section 3 outputs the address signal to the memory 230 at a first speed. On the other hand, in 2-phase expansion (i.e. when the first liquid crystal panel 610 is to display an image), the read controlling section 3 outputs the address signal to the memory 230 at a second speed which is a speed faster than the first speed. Thus, the image data in the memory 230 is read as a digital image signal by the switching output section 233 at a speed corresponding to the phase expansion. It should be noted here that the signal which is read from the memory 230 and represents image data has a bit-width appropriate for the number of halftones for the display. For simplicity, however, description hereinafter will be made, again, as if the signal were sent/received through a single line.

In the first embodiment described above, the switching output section 231 outputs the digital image signal while switching between a total of nine signal lines, i.e. six upper lines and three lower lines. On the contrary, in the present embodiment, the switching output section 233 outputs the digital image signal while switching between six signal lines. Specifically, the read controlling section 3 outputs to the switching output section 233 a switching control signal for changing the connection relationship between the output signal line of the memory 230 and the six signal lines. More specifically, in 2-phase expansion, the switching control signal is a signal which causes sequential switching in the connection of the output-side signal line of the memory 230 with one of the six signal lines which go into the first liquid crystal panel 610. In 1-phase expansion, the switching control signal is a signal which causes sequential switching in the connection of the output-side signal line of the memory 230 with one of the upper three signal lines of the above-described six lines which go into the second liquid crystal panel 620. The buffer section 234 receives all the digital image signals outputted sequentially from the switching output section 233 via the signal lines, and output these signals simultaneously. Thus, in 2-phase expansion, the buffer section 234 receives digital image signals which are sent sequentially from the switching output section 233 via the six signal lines, and outputs all of these digital image signals to the gamma conversion section 25 at a single timing. In 1-phase expansion on the other hand, the buffer section 234 receives digital image signals which are sent sequentially from the switching output section 231 via the upper three signal lines of the six lines, and outputs all of these digital image signals to the gamma conversion section 25 at a single timing. Thus, when the panel indication signal PS sent from outside indicates that the first liquid crystal panel 610 should be the working panel, the output is as shown in FIG. 5A, i.e. digital image signals resulted from a 2-phase expansion operation is outputted from the image memory section 23. On the other hand, when the panel indication signal PS sent from outside indicates that the second liquid crystal panel 620 should be the working panel, the output is as shown in FIG. 5B, i.e. digital image signals resulted from a 1-phase expansion operation is outputted from the image memory section 23.

Now, the above-described arrangement may be replaced by the following: Specifically, whether the first liquid crystal panel 610 or the second liquid crystal panel 620 is the working panel, only a 2-phase expansion signal is generated from an image data read from the image memory section 23. In other words, there may be only one phase expansion means provided by the switching output section 233, the buffer section 234 and the read controlling section 3, provided that the image memory section 23 includes the memory 230. Then, when the smaller, second liquid crystal panel 62b is the working panel, not all of the signals given to the six buffers B(R1), B(G1), B(B1), B(R2), B(G2), B(B2) in the analog output section 27 based on the 2-phase expansion process are used, but only those analog image signals outputted from the buffers B(R1), B(G1), B(B1) which are connected to the shared video signal lines R1, G1, B1 are used for the image display on the liquid crystal panel 620.

The analog output section 27 includes two sets of buffers: the first is a set of three buffers B(R1), B(G1), B(B1) for supplying the first-phase portion of the analog video signal AV to the first liquid crystal panel 610 (i.e. the source driver 300 therein), or for supplying an analog video signal AV to the second liquid crystal panel 620 (i.e. the source driver 300 therein); and the other is a set of three buffers B(R2), B(G2), B(B2) for supplying the second-phase portion of the analog video signal AV to the first liquid crystal panel (i.e. the source driver 300 therein)

The host interface section 22, the gamma conversion section 25 and the D/A conversion section 26 operate in the same way as in the first embodiment, so details will not be repeated here. The timing generator section 21 receives the panel indication signal PS, and generates the above-mentioned source start pulse signal SSP, source clock signal SCK, gate start pulse signal GSP, and gate clock signal GCK so that the image will be displayed at appropriate timing on the display section 500 of the liquid crystal panel, as well as generating a timing signal for the host interface section 22, the gamma conversion section 25 and the D/A conversion section 26 to work at appropriate timing. The phase switching section 2 in the timing generator section 21 generates a first buffer control signal SB1 and a second buffer control signal SB2 based on the panel indication signal PS, for output control of the analog video signal AV to each of the liquid crystal panels, as well as generating a first switch control signal SW1 and a second switch control signal SW2 for controlling switches (to be described later) provided in each of the liquid crystal panels 610, 620. The analog output section 27 outputs an analog video signal AV to all of the six video signal lines or the three of the six video signal lines, depending on the first buffer control signal SB1 and the second buffer control signal SB2 from the phase switching section 2. The switches which are provided in each of the liquid crystal panels 610, 620 and are to be described later are used so that one of the first and the second liquid crystal panels which are not selected as the working panel will not become a load (capacitive load) on the analog output section 27.

Next, more detailed description will be made for the operation of the analog output section 27. Of the buffers included in the analog output section 27, the buffers B(R1), B(G1) and B(B1) which supply the analog video signal AV to both of the first liquid crystal panel 610 and the second liquid crystal panel 620 are switched by a first buffer control signal SB1, to take an operating state or a non-operating state. On the other hand, the buffers B(R2), B(G2) and B(B2) which supply the analog video signal AV only to the first liquid crystal panel 620 are switched by a second buffer control signal SB2, to take an operating state or a non-operating state. Each of the buffers takes the operating state, i.e. outputs an analog video signal AV, when the buffer control signal assumes HIGH level. On the other hand, when the buffer control signal assumes LOW level, the buffer takes the non-operating state, i.e. stops the output of analog video signal AV. FIG. 10 is a diagram illustrating the states of the first buffer control signal SB1 and the second buffer control signal SB2. When the first liquid crystal panel 610 is the working panel, both the first buffer control signal SB1 and the second buffer control signal SB2 assume HIGH level. On the other hand, when the second liquid crystal panel 620 is the working panel, the first buffer control signal, SB1 assumes HIGH level whereas the second buffer control signal SB2 assumes LOW level. By giving the first buffer control signal SB1 and the second buffer control signal SB2 as described, from the phase switching section 2 to the analog output section 27, the buffers B(R2), B(G2), and B(B2) which are supposed to supply analog video signals AV only to the first liquid crystal panels 620 stop their operation when the second liquid crystal panel 620

According to the present embodiment, some of the video signal lines which connect the liquid crystal panel drive circuit 200 with the liquid crystal panels 610, 620 are shared as described above. Such an arrangement will cause a problem that the analog output section 27 comes under a burden of two capacitive loads from the two liquid crystal panels, with whichever of the first and the second liquid crystal panels 610, 620 being driven. Thus, the analog output section 27 will have to be provided with high-performance buffers, leading to increased power consumption. With this scenario, the present embodiment employs the following circuit configuration in order to avoid the situation that the liquid crystal panel other than the working panel becomes a load on the analog output section 27.

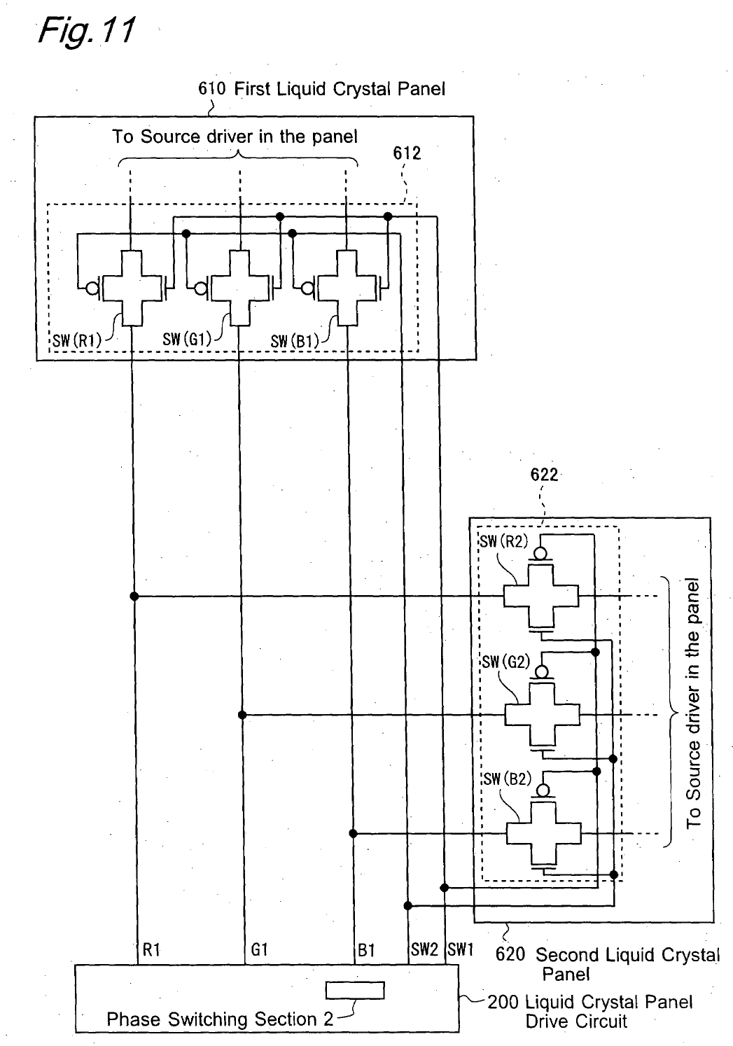

FIG. 11 is a circuit diagram which shows an example configuration of a circuit for reducing the capacitive load on the analog output section 27. Note that FIG. 11 only shows the first liquid crystal panel 610, the second liquid crystal panel 620, the video signal lines R1, G1, B1 shared thereby, and their related elements. As shown in FIG. 11, in this example, the first liquid crystal panel 610 has a first switch circuit 612 formed therein, which is provided by three analog switches SW (R1), SW(G1), SW(B1), and the second liquid crystal panel 620 has a second switch circuit 622 formed therein, which is provided by three analog switches SW(R2), SW(G2), SW(B2). The video signal lines R1, G1, B1 are connected with the analog switches SW(R1), SW(G1), SW(B1) in the first liquid crystal panel 610 respectively. Further, the video signal lines R1, G1, B1 are connected with the analog switches SW (R2) SW (G2), SW (B2) in the second liquid crystal panel 620 respectively. Each of the analog switches in the first liquid crystal panel 610 and the second liquid crystal panel 620 are supplied with the first switch control signal SW1 and the second switch control signal SW2 outputted from the phase switching section 2 in the liquid crystal panel drive circuit 200. Each of the analog switches in the first switch circuit 612 of the first liquid crystal panel 610 is turned ON when the first switch control signal SW1 assumes HIGH level and the second switch control signal SW2 assumes LOW level. On the other hand, each of the analog switches in the second switch circuit 622 of the second liquid crystal panel 620 is turned ON when the first switch control signal SW1 assumes LOW level and the second switch control signal SW2 assumes HIGH level.

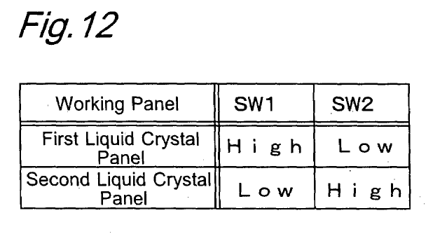

FIG. 12 is a diagram for describing the states of the first switch control signal SW1 and the second switch control signal SW2. When the first liquid crystal panel 610 is the working panel, the first switch control signal SW1 assumes HIGH level whereas the second switch control signal SW2 assumes LOW level. Under this state, all of the analog switches included in the first switch circuit 612 of the first liquid crystal panel 610 are turned ON, whereas all of the analog switches included in the second switch circuit 622 of the second liquid crystal panel 620 are turned OFF. Thus, the second liquid crystal panel 620 is electrically separated from the shared video signal lines R1, G1, and B1, and therefore does not become a load on the analog output section 27. On the other hand, when the second liquid crystal panel 620 is the working panel, the first switch control signal SW1 assumes LOW level while the second switch control signal SW2 assumes HIGH level. Under this state, all of the analog switches included in the first switch circuit 612 of the first liquid crystal panel 610 are turned OFF whereas all of the analog switches included in the second switch circuit 622 are turned ON. Thus, the first liquid crystal panel 610 is electrically separated from the shared video signal lines R1, G1, and B1, and therefore does not become a load on the analog output section 27.

<2.3 Advantages>

As has been described thus far, according to the present embodiment again, the only one liquid crystal panel drive circuit 200 provided in the liquid crystal display apparatus can drive two liquid crystal panels which are different in sizes, and therefore, enables to reduce the circuit size as compared to conventional liquid crystal display apparatuses which have two liquid crystal panels of different sizes, and in addition, to further reduce the size of the liquid crystal display apparatus. Also burden in designing a liquid crystal panel drive circuit for each of the liquid crystal panel is reduced. Further, according to the present embodiment, the first liquid crystal panel 610 and the second liquid crystal panel 620 share the video signal lines R1, G1, B2, and the liquid crystal panel other than the working panel is electrically separated from the shared video signal lines R1, G1, B2; enabling to further reduce the circuit size while reducing an increase in power consumption.

<3. Variations>

In each of the above embodiments, an example was used where switching is made between 2-phase expansion and 1-phase expansion. However, the present invention is not limited to this. The present invention is applicable to many other combinations than described so far, such as switching between 3-phase expansion and 2-phase expansion, or switching between three or greater phase-expansion operations of different number of phases.

In each of the above embodiments, an example was used where the liquid crystal display apparatus has two liquid crystal panels of different sizes; however, the present invention is not limited to this. In other words, the liquid crystal panel drive circuit according to any of the above-described embodiments may be applied to a liquid crystal display apparatus which has only one liquid crystal panel. In this case, there is no need for phase expansion signals for the sub panel; yet the liquid crystal panel drive circuit according to the above-described embodiment is able to output whichever of the 2-phase expansion signal and the 1-phase expansion signal, in accordance with the source drive provided in the only one liquid crystal panel, i.e. the circuit can be used for a specific kind of signal to be outputted to the only one liquid crystal panel. Therefore, even if the present invention is applied to a liquid crystal display apparatus which has only one liquid crystal panel, the invention still provides a commonality advantage that one liquid crystal panel drive circuit is applicable to a variety of liquid crystal panels in which the number of phases in the phase expansion process is not the same.

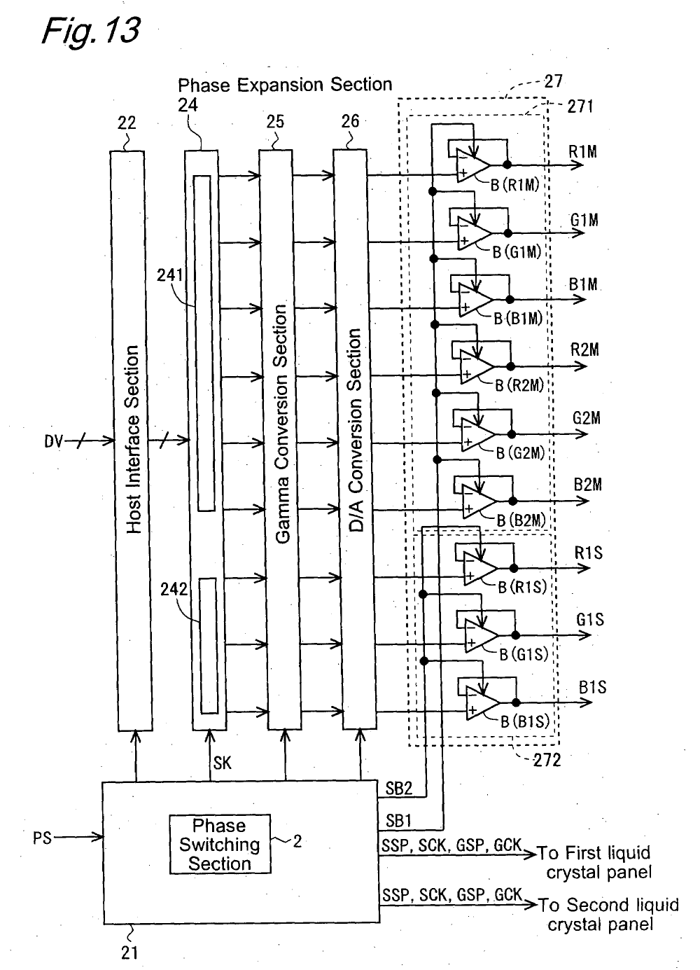

In each of the above embodiments, an example uses a method called “CPU interface”. This is a method where an outside CPU or the like provides an interface through which the image to be displayed is entered from outside (the host, including a CPU) to the liquid crystal display apparatus, i.e. the CPU writes the image data to the image memory section 23 in the liquid crystal panel drive circuit 200. However, the present invention is also applicable to a method called “HV interface” in which the image signal is entered to the liquid crystal display apparatus together with line synchronizing signals, frame synchronizing signals and dot clock signals. Assume, for example, that the first embodiment uses an HV interface in place of a CPU interface. Then, the liquid crystal panel drive circuit 200 may be made as shown in FIG. 13. Under this configuration, the liquid crystal panel drive circuit 200 operates as described below. Note that in the following description, the same or corresponding portions as those in the liquid crystal panel drive circuit 200 according to the first embodiment will be indicated by the same reference symbols, with their details not described here again.

According to this configuration, the image memory section 23 in the first embodiment is replaced by a phase expansion section 24, and the timing generator section 21 does not have the read controlling section 3. The phase switching section 2 in the timing generator section 21 according to the present configuration generates, based on the panel indication signal PS, a phase switching control signal SK for switching control in the phase expansion process made by the phase expansion section 24, and gives the signal to the phase expansion section 24. Based on the phase switching control signal SK, the phase expansion section 24 generates an image data from the image signal (image data) outputted from the host interface section 22 for input to the gamma conversion section 25. In other words, the phase expansion section 24 includes a first phase-expansion section 241 and a second phase-expansion section 242, and when the panel indication signal PS sent from outside indicates that the image should be displayed on the first liquid crystal panel 610, the first phase-expansion section 241 performs a 2-phase expansion process, thereby generates a 2-phase expansion signal, and gives it to the gamma conversion section 25. On the other hand, when the panel indication signal PS from outside indicates that the image should be displayed on the second liquid crystal panel 620, the second phase-expansion section 242 performs a 1-phase expansion process thereby generates a 1-phase expansion signal, and gives it to the gamma conversion section 25. The operation thereafter is the same as in the first embodiment. Such an arrangement as described provides the same advantages as those provided by the first embodiment, except those which are related to the image memory section. The first and the second phase-expansion sections 241, 242 can be provided by multi-stage latches.

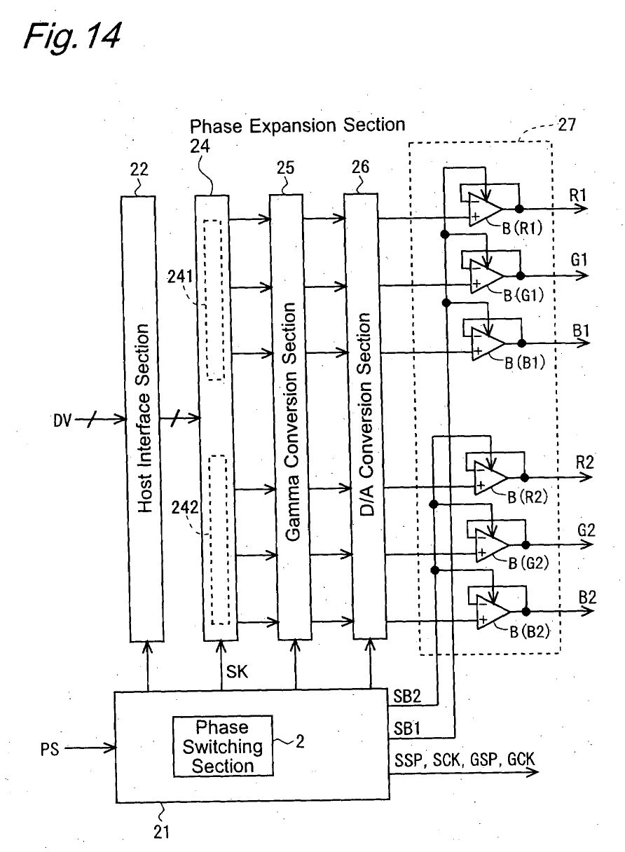

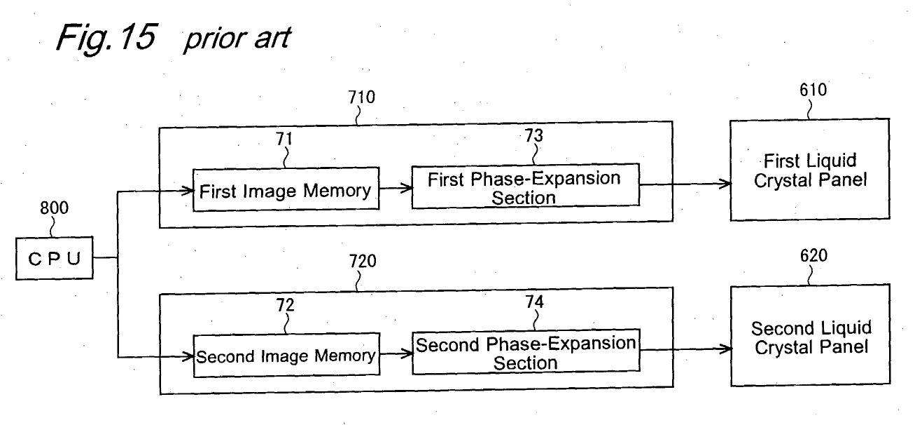

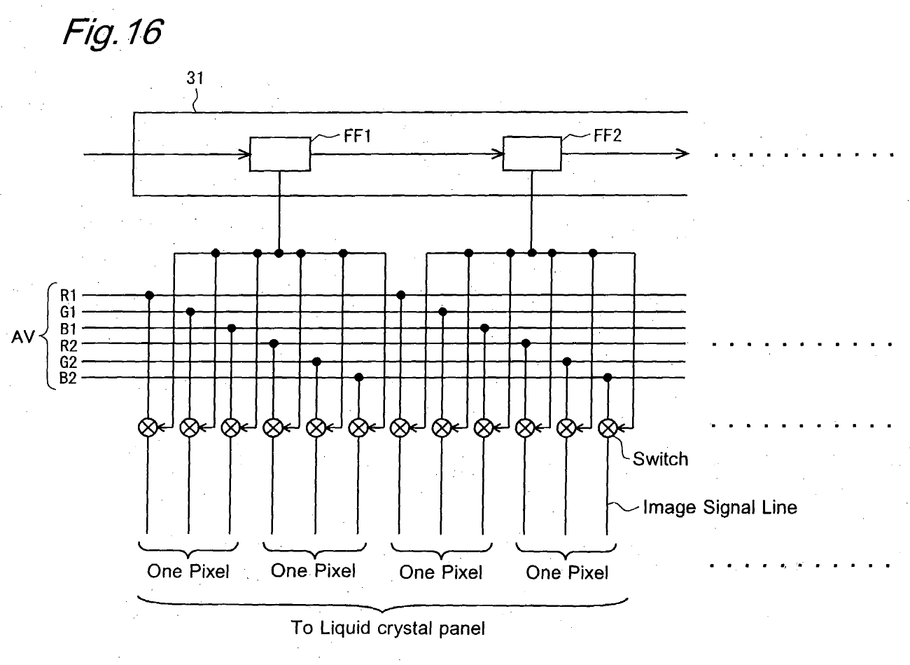

Likewise, if the second embodiment uses HV interface in place of CPU interface, then the liquid crystal panel drive circuit 200 may be made as shown in FIG. 14. (Again, note that in the following description, the same or corresponding portions as those in the liquid crystal panel drive circuit 200 according to the second embodiment will be indicated by the same reference symbols, with their details not described here). Under this arrangement, the image memory section 23 in the second embodiment is replaced by a phase expansion section 24, and the timing generator section 21 does not have the read controlling section 3. Such an arrangement provides the same advantages as those provided by the second embodiment, except those which are related to the image memory section. The phase expansion section 24 may be like the arrangement shown in FIG. 13, i.e. may include two expansion sections provided by the first phase-expansion section 241 for 2-phase expansion and the second phase-expansion section 242 for 1-phase expansion, or it may only include one phase expansion section for 2-phase expansion, provided that the first liquid crystal panel 610 and the second liquid crystal panel 620 share the phase expansion section. If the latter case is used and when the smaller, second liquid crystal panel 620 is the working panel, not all of the analog image signals given to the six buffers B(R1), B(G1), B(B1), B(R2), B(G2), B(B2) in the analog output section 27 based on the 2-phase expansion process are used, but only analog image signals outputted from the buffers B(R1), B(G1), B(B1) which are connected to the shared video signal lines R1, G1, B1 are used for the display on the second liquid crystal panel 620.

According to each of the embodiments (the first and the second), phase expansion sections work in the following procedure: Digital image signal which represents image data is read from the memory 230 at a speed corresponding to the phase expansion, outputted by the image memory section 23 while the switching output sections 231, 233 make switching between a plurality of signal lines, and thereafter, the buffer sections 232, 234 make their output at a single timing. However, the method of providing the phase expansion means is not limited to this. For example, the image memory section 23 may be made to allow reading of data simultaneously for two pixels. In this arrangement, reading of data from the memory is made for one pixel or for two mutually adjacent pixels, in accordance with the panel indication signal PS, under the control provided by the phase switching section 2, and the address signal and the control signal issued from the read controlling section 3 to the memory 230. In this arrangement, the image memory section 23 does not require the switching output sections 231, 233 or the buffer sections 232, 234. When the panel indication signal PS sent from outside indicates that the first liquid crystal panel 610 should be the working panel, the read controlling section 3 performs as shown in FIG. 5A, i.e. reading the image data from the memory 230 for two pixels at a time so that the digital image signal is outputted in 2-phase expansion, whereas when the panel indication signal PS sent from outside indicates that the second liquid crystal panel 620 should be the working panel, the image data reading from the memory 230 is made for a single pixel at a time as shown in FIG. 5B so that the digital image signal is outputted in 1-phase expansion.

It should also be noted here, that in each of the embodiments, the gate driver 400 is formed in the liquid crystal panel as is the source driver 300; however, the gate driver 400 need not be formed in the liquid crystal panel, and be provided by a separate IC instead.

Further, in each of the embodiments and in the variations, the panel indication signal PS is given from outside to the liquid crystal panel drive circuit 200, as a signal that designates one of the first and the second liquid crystal panels 610, 620 as the displaying liquid crystal panel, i.e. the working panel. However, the working panel may be designated in different methods other than through the use of the panel indication signal PS. For example, if the apparatus uses CPU interface, a control register may be provided in the liquid crystal panel drive circuit 200 so that the outside CPU can send a control data for designating the working panel to the register. If the apparatus uses HV interface, a control register may be provided in the liquid crystal panel drive circuit 200, so that a control data for designating the working panel is sent to the register from outside via a separate serial interface for example.

### INDUSTRIAL APPLICABILITY

The present invention is applicable to drive circuits for driver monolithic liquid crystal panels, i.e. drive circuits for liquid crystal panels in which their data signal drive circuit and other components are formed integrally with the display section on the same substrate. The invention is also applicable to liquid crystal display apparatuses including such a drive circuit. In particular, the present invention is suitable to liquid crystal display apparatuses which have a plurality of driver monolithic liquid crystal panels of different sizes.

1. A drive circuit for driving a driver monolithic liquid crystal panel including: a plurality of pixel formation sections for forming an image to be displayed; a plurality of data signal lines for supplying the pixel formation sections with signals which represent the image to be displayed; and a data signal line drive circuit for driving the data signal lines in dot sequential drive method by sequential application to the data signal lines of image signals inputted as a representation of the image to be displayed; the drive circuit for driving the driver monolithic liquid crystal panel comprising:
a first phase-expansion section for generating a first phase-expansion signal which is a digital image signal made from image data inputted as a representation of the image to be displayed, through phase expansion into a first number of phases;
a second phase-expansion section for generating a second phase-expansion signal which is a digital image signal made from the image data through phase expansion into a second number of phases that is smaller than the first number of phases;
an output section for outputting an image signal which is equivalent to the first or the second phase-expansion signal, as the image signal to be inputted to the data signal line drive circuit; and
a switching section for switching the image signal outputted from the output section, at least between the image signal which is equivalent to the first phase-expansion signal and the image signal which is equivalent to the second phase-expansion signal.

2. The drive circuit according to claim 1, further comprising a memory for storing the image data,
wherein the first phase-expansion section generates the first phase-expansion signal by reading and processing the image data from the memory at a speed corresponding to the first number of phases, and
wherein the second phase-expansion section generates the second phase-expansion signal by reading and processing the image data from the memory at a speed corresponding to the second number of phases.

3. The drive circuit according to claim 1, further comprising a memory for storing the image data,
wherein the first phase-expansion section is provided by a read controlling section which reads the image data from the memory so that data read from the memory provides the first phase-expansion signal, and
wherein the second phase-expansion section is provided by a read controlling section which reads the image data from the memory so that data read from the memory provides the second phase-expansion signal.

4. The drive circuit according to claim 1, further comprising a conversion section for generating a first analog image signal by converting the first phase-expansion signal into an analog signal, and a second analog image signal by converting the second phase-expansion signal into an analog signal,
wherein the output section includes:
a first output buffer section for outputting the first analog image signal as the image signal to be inputted to the data signal line drive circuit; and
a second output buffer section for outputting the second analog image signal as the image signal to be inputted to the data signal line drive circuit.

5. The drive circuit according to claim 4, further comprising a buffer control section for stopping operation of the second output buffer section when the first analog image signal is outputted from the output section via the first output buffer section, and for stopping operation of the first output buffer section when the second analog image signal is outputted from the output section via the second output buffer section.

6. The drive circuit according to claim 1, further comprising a conversion section for generating a first analog image signal by converting the first phase-expansion signal into an analog signal, and a second analog image signal by converting the second phase-expansion signal into an analog signal,
wherein the output section
includes a number of buffers corresponding to the first number of phases for outputting the first analog image signal as the image signal to be inputted to the data signal line drive circuit, and
outputs the second analog image signal, if the image signal to be outputted from the output section is the second analog image signal which is equivalent to the second phase-expansion signal, via a number of buffers corresponding to the second number of phases which are those buffers preselected from the number of buffers corresponding to the first number of phases.

7. The drive circuit according to claim 6, further comprising a buffer control section for stopping operation of those buffers that are not preselected from the number of buffers corresponding to the first number of phases when the second analog image signal is outputted from the output section via the preselected buffers.

8. A liquid crystal display apparatus comprising:
the drive circuit according to claim 1;
a first liquid crystal panel categorized as the driver monolithic liquid crystal panel, for displaying an image based on an image signal outputted from the output section when the image signal is equivalent to the first phase-expansion signal; and
a second liquid crystal panel categorized as the driver monolithic liquid crystal panel, for displaying an image based on an image signal outputted from the output section when the image signal is equivalent to the second phase-expansion signal.

9. A liquid crystal display apparatus comprising:
the drive circuit according to claim 6;
a first liquid crystal panel categorized as the driver monolithic liquid crystal panel, for displaying an image based on the first analog image signal;
a second liquid crystal panel categorized as the driver monolithic liquid crystal panel, for displaying an image based on the second analog image signal; and
a number of signal lines corresponding to the first number of phases for sending the first analog image signal to the first liquid crystal panel when the first analog image signal is outputted from the output section;
wherein the second analog image signal outputted from the output section is sent to the second liquid crystal panel by a number of signal lines corresponding to the second number of phases which are those lines preselected from the number of signal lines corresponding to the first number of phases.

10. The liquid crystal display apparatus according to claim 9, further comprising;
a first switch circuit for making an electric connection of the first liquid crystal panel with the preselected signal lines when the first analog image signal is outputted from the output section, and for making an electric separation of the first liquid crystal panel from the preselected signal lines when the second analog image signal is outputted from the output section; and
a second switch circuit for making an electric separation of the second liquid crystal panel from the preselected signal lines when the first analog image signal is outputted from the output section, and for making an electric connection of the second liquid crystal panel with the preselected signal lines when the second analog image signal is outputted from the output section.

11. A liquid crystal display apparatus which utilizes a driver monolithic liquid crystal panel including: a plurality of pixel formation sections for forming an image to be displayed; a plurality of data signal lines for sending signals representing the image to be displayed to the pixel formation sections; and a data signal line drive circuit for driving the data signal lines in dot sequential drive method by sequential application to the data signal lines of image signals inputted as a representation of the image to be displayed; the apparatus comprising:
a first liquid crystal panel categorized as the driver monolithic liquid crystal panel, for displaying an image based on an image signal processed through phase expansion into a first number of phases;
a second liquid crystal panel categorized as the driver monolithic liquid crystal panel, for displaying an image based on an image signal processed through phase expansion into a second number of phases that is smaller than the first number of phases;
a phase expansion section for generating a digital image signal from image data inputted as a representation of the image to be displayed, through phase-expansion into the first number of phases;
an output section for outputting an image signal which is equivalent to the digital image signal generated by the phase expansion section; and
a number of signal lines corresponding to the first number of phases, for sending the image signal outputted from the output section to the first liquid crystal panel,
wherein the image signal outputted from the output section for display of an image on the second liquid crystal panel is sent to the second liquid crystal panel by a number of signal lines corresponding to the second number of phases which are those lines preselected from the number of signal lines corresponding to the first number of phases.

12. The liquid crystal display apparatus according to claim 11, further comprising a memory for storing the image data,
wherein the phase expansion section generates a phase-expanded digital image signal by reading and processing the image data from the memory at a speed corresponding to the first number of phases.

13. The liquid crystal display apparatus according to claim 11, further comprising a memory for storing the image data,
wherein the phase-expansion section is provided by a read controlling section which reads the image data from the memory so that data read from the memory provides the phase-expanded digital image signal.

14. The liquid crystal display apparatus according to claim 11, further comprising a switching section for switching the image signal outputted from the output section between an image signal for display of an image on the first liquid crystal panel and an image signal for display of an image on the second liquid crystal panel.

15. The liquid crystal display apparatus according to claim 14, further comprising a conversion section for converting the digital image signal generated by the phase expansion section into an analog image signal,
wherein the output section
includes a number of buffers corresponding to the first number of phases for outputting the analog image signal to said number of the signal lines corresponding to the first number of phases, and
outputs the analog image signal, if the image signal outputted from the output section is for display of an image on the second liquid crystal panel, to the preselected lines via a number of buffers corresponding to the second number of phases which are those buffers preselected from the number of buffers corresponding to the first number of phases.

16. The liquid crystal display apparatus according to claim 15, further comprising a buffer control section for stopping operation of the other buffers than those preselected from the number of buffers corresponding to the first number of phases when the analog image signal outputted from the output section is for display of an image on the second liquid crystal panel.

17. The liquid crystal display apparatus according to claim 14, further comprising
a first switch circuit for making an electric connection of the first liquid crystal panel with the preselected signal lines when the image signal outputted from the output section is for display of an image on the first liquid crystal, and for making an electric separation of the first liquid crystal panel from the preselected signal lines when the image signal outputted from the output section is for display of an image on the second liquid crystal; and
a second switch circuit for making an electric separation of the second liquid crystal panel from the preselected signal lines when the image signal outputted from the output section is for display of an image on the first liquid crystal, and for making an electric connection of the second liquid crystal panel with the preselected signal lines when the image signal outputted from the output section is for display of an image on the second liquid crystal.
